(19) United States
(12) Patent Application Publication
(10) Pub. No.: US 2016/0357448 A1
(43) Pub. Date: Dec. 8, 2016

(54) NETWORK SWITCH AND DATABASE UPDATE WITH BANDWIDTH AWARE MECHANISM

(71) Applicant: MEDIATEK INC., Hsin-Chu (TW)

(72) Inventors: Shu-Ping Lin, New Taipei City (TW); Chien-Cheng Chiang, Taipei City (TW)

(21) Appl. No.: 14/946,791

(22) Filed: Nov. 20, 2015

Related U.S. Application Data
(60) Provisional application No. 62/170,705, filed on Jun. 4, 2015.

(51) Int. Cl. G06F 3/06

(52) U.S. Cl. CPC G06F 3/0607; G06F 3/0631; G06F 3/067; G06F 3/0656

(57) ABSTRACT

A network switch comprising: a first storage unit, configured to store a first data base; a first buffer, configured to buffer data to be updated; and an update managing module, configured to assign a first update address of the first storage unit, which is for the data to be updated, according to first buffer information for the first buffer and a first update request.

### CROSS REFERENCE TO RELATED APPLICATIONS

This application claims the benefit of U.S. Provisional Application No. 62/170,705, filed on Jun. 4, 2015, the contents of which are incorporated herein by reference.

### BACKGROUND

A network switch is applied to transmit data between a plurality of electronic apparatuses. The network switch keeps learning (updating) relations between MAC addresses and pipe line modules (ex. ports), such that the network switch can efficiently transmit data to a required destination. Specifically, the network switch keeps learning relations between MAC addresses and pipe line modules to generate a MAC address table, and the network switch lookups the MAC address table to find the pipe line module corresponding to the required destination.

The MAC address table needs to be continuously updated such that the data transmitting efficiency can be optimized. More specifically, if the MAC address table is requested to be updated, one index of the MAC address table is chosen for learning. After that, the data to be updated (to be learned) arrives the chosen memory address. However, if the memory does not have enough write bandwidth, the learning fails and the whole process repeats again.

### SUMMARY

Accordingly, one objective of the present application is to provide a network switch that can refer bandwidth information to assign update addresses.

Another objective of the present application is to provide a data base updating method that can refer bandwidth information to assign update addresses.

One embodiment of the present application discloses: a network switch comprising: a first storage unit, configured to store a first data base; a first buffer, configured to buffer data to be updated; and an update managing module, configured to assign a first update address of the first storage unit, which is for the data to be updated, according to first buffer information for the first buffer and a first update request.

Another embodiment of the present application discloses a network switch comprising: a first die; a second die; and an update managing module, configured to assign at least one update address for at least one storage unit according to bandwidth information from the first die and the second die.

Another embodiment of the present application discloses a data base updating method comprising: buffering data to be updated to via a first buffer; and assigning a first update address of the first storage unit, which is for the data to be updated, according to a first update request and first buffer information for the first buffer.

In view of above-mentioned embodiments, the real-time band width information can be acquired thus the update address can be efficiently assigned.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1-FIG. 5 are block diagrams illustrating network switches according to different embodiments of the present invention.

FIG. 6 is a circuit diagram illustrating a detail structure for the update managing module according to one embodiment of the present invention.

### DETAILED DESCRIPTION

In the following, several embodiments are provided to explain the concept of the present application. Please note, in the following embodiments, the operations for the network switch can be controlled by a control unit or any device that can control the network switch. Further, in the following embodiments, all devices can be implemented by hardware (ex. a circuit) or hardware with software (ex. processing unit executing a specific program).

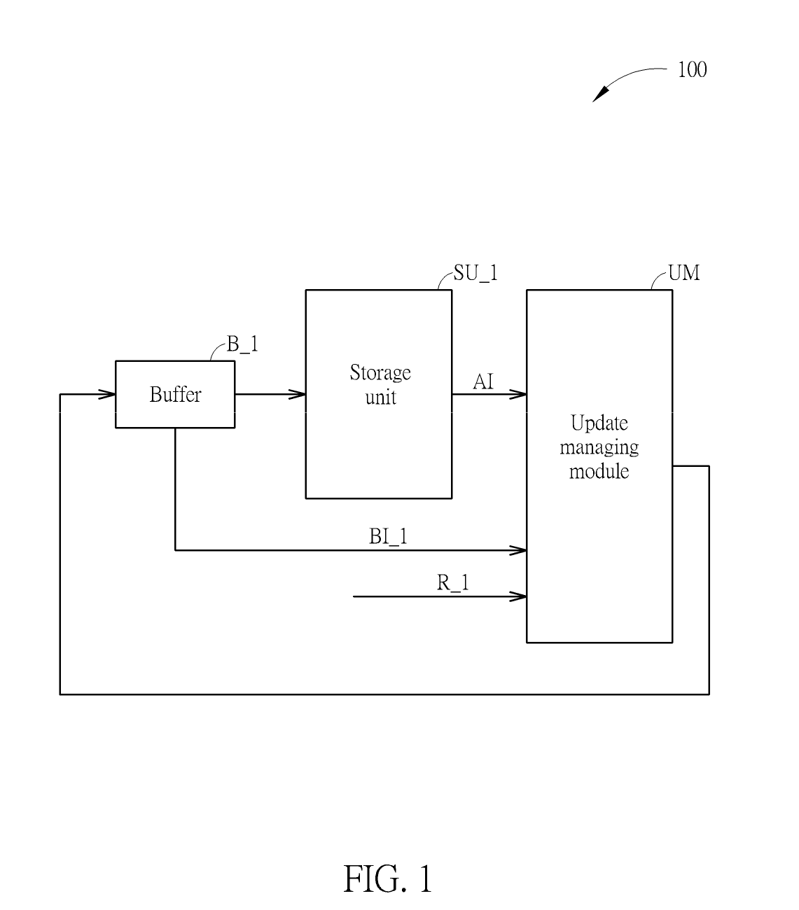

FIG. 1-FIG. 5 are block diagrams illustrating network switches according to different embodiments of the present invention. As illustrated in FIG. 1, the network switch 100 comprises a first storage unit SU_1, a first buffer B_1, and an update managing module UM. The first storage unit SU_1 (ex. a memory) is configured to store a first data base. The first buffer B_1 is configured to buffer data to be updated to the first storage unit SU_1. The update managing module UM is configured to select a first update address for the first data base according to the first update request R_1 and first buffer information BI_1. In one embodiment, the update managing module UM further receives address information AI, which indicates if addresses in the first storage unit SU_1 are available or not. The first buffer information BI_1 indicates the condition of the buffer (ex. space), and can be used as an index with backpressure.

More specifically, if the first buffer information BI_1 indicates the first buffer B_1 buffers much data, it means the first storage unit SU_1 does not have sufficient band width to process the data to be updated. For example, if the data amount buffered in the first buffer B_1 is over a threshold value or the available space of the first buffer B_1 is lowered than a threshold value, it means much data is waiting to be updated, thus the first storage unit SU_1 may not have sufficient bandwidth. In such case, the update managing module UM does not send data to be updated to the first buffer B_1 according to the first update request R_1. In such case, the update managing module UM re-assigns the first update address and the data to be updated will be sent to another address for updating.

More specifically, in one example, the first update request R_1 requests to update data to one address A (i.e. the above-mentioned first update address), and the first buffer B_1 is configured to buffer data to be updated to the address A. If the first buffer information BI_1 indicates the data amount buffered in the first buffer B_1 is less than a threshold value, it means the path to the address A has sufficient bandwidth, thus the first update request R_1 is accepted and the data to be updated will be transmitted to the first buffer B_1 and waits to be updated. On the contrary, if the first buffer information BI_1 indicates the data amount buffered in the first buffer B_1 is more than the threshold value, it means the path to the address A does not have sufficient bandwidth. In such case, the data to be updated may be assigned to another address B (i.e. the address is re-assigned).

In one embodiment, the storage unit comprises more than one storage sections. The storage sections can be, for example, a memory page or a memory bank if the storage unit is a memory, but not limited. In one embodiment, the above-mentioned address A and the address B belong to the same storage section. In another embodiment, the above-mentioned address A and the address B belong to different storage section.

Further, in one embodiment, the storage unit SU_1 can receive a lookup command to search the relation between a MAC address and a pipe line module. For more detail, the MAC address to be searched is applied as input “key”, then search in the MAC address table, if there is same key stored in the memory, then it fetch the associate date from matched index.

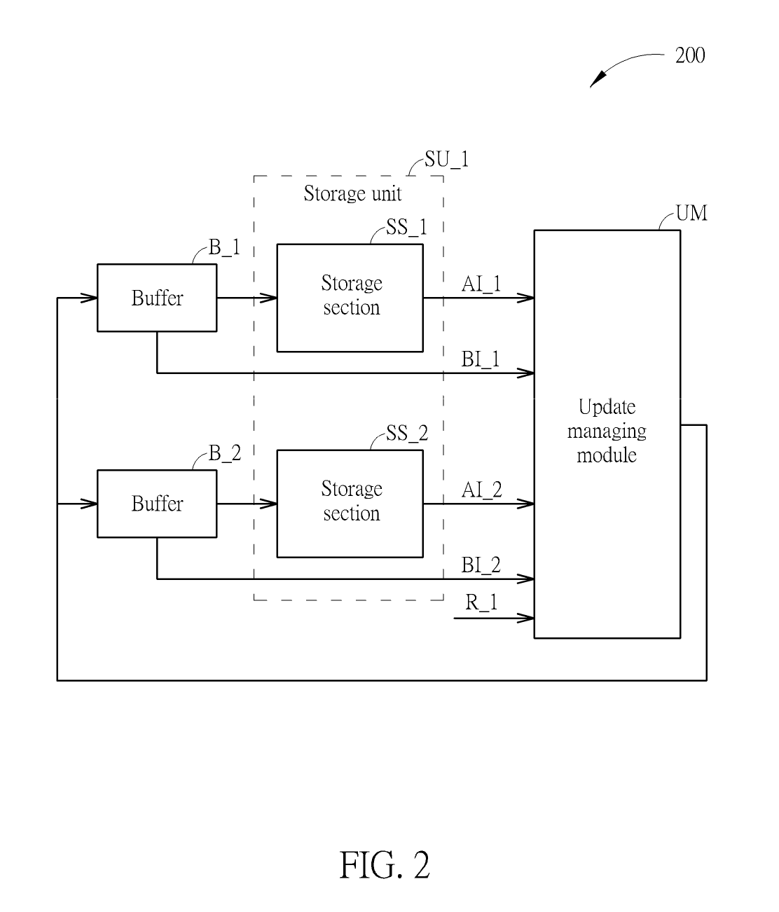

In the embodiment of FIG. 2, the first storage unit SU_1 comprises a first storage section SS_1 and a second storage section SS_2, and the network switch 200 further comprises a second buffer B_2. As illustrated in FIG. 2, the first buffer B_1 is configured to buffer data to be updated to the first storage section SS_1, and the second buffer B_2 is configured to buffer data to be updated to the second storage section SS_2. In this embodiment, the update managing module UM receives the first address information AI_1 from the first storage section SS_1 and the second address information AI_2 from the second storage section SS_2, which respectively indicate if addresses in the first storage section SS_1 and the second storage section SS_2 are available or not.

In the embodiment of FIG. 2, the update managing module UM assigns the first update address according to the first buffer information BI_1 for the first buffer B_1 and the second buffer information BI_2 for the second buffer B_2. In one embodiment, the data to be updated to the first storage section SS_1 will be assigned to the second storage section SS_2 by the update managing module UM if the first buffer information BI_1 indicates the first storage section SS_1 does not have enough bandwidth. That is, the address A in the above-mentioned example related with FIG. 1 belongs to the first storage section SS_1, and the above-mentioned address B belongs to the second storage section SS_2.

In one embodiment, the first storage section SS_1 and the second storage section SS_2 belong to a single data transmitting path (ex. a pipe line module or a port).

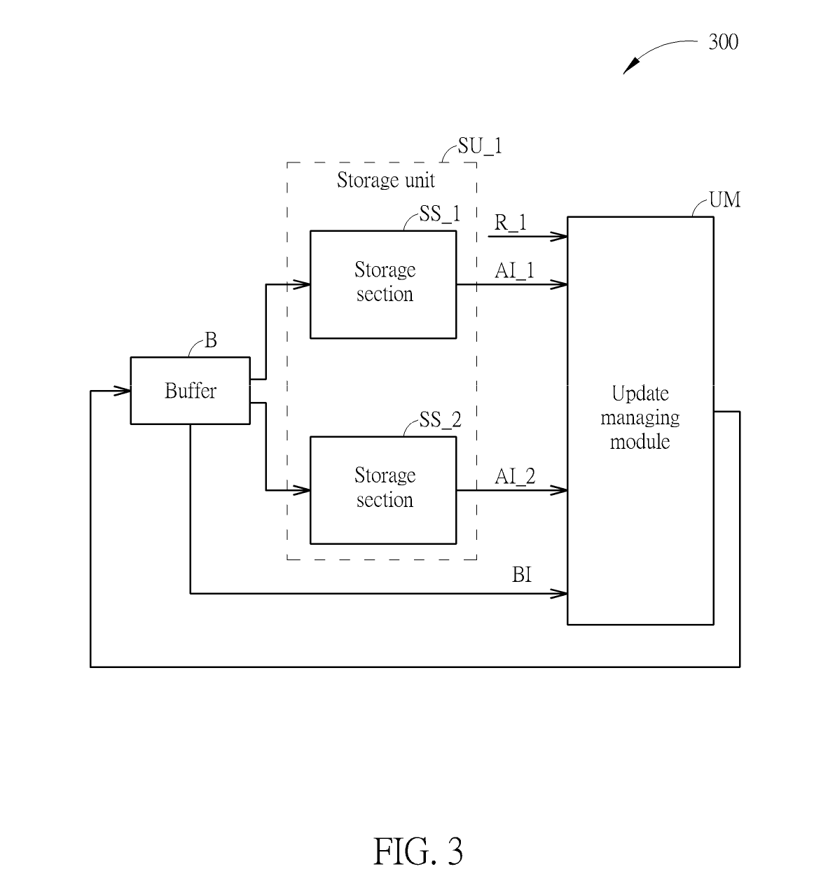

FIG. 3 is a block diagram illustrating a network switch according to another embodiment of the present application. In the embodiment of FIG. 3, the network switch 300 comprises a buffer which is shared by more than one storage sections. For more detail, the first storage unit SU_1 comprises a first storage section SS_1 and a second storage section SS_2. As illustrated in FIG. 3, the buffer B is configured to buffer data to be updated to the first storage section SS_1, and the data to be updated to the second storage section SS_2. The update managing module UM assigns the update address according to the buffer information BI for the first buffer B.

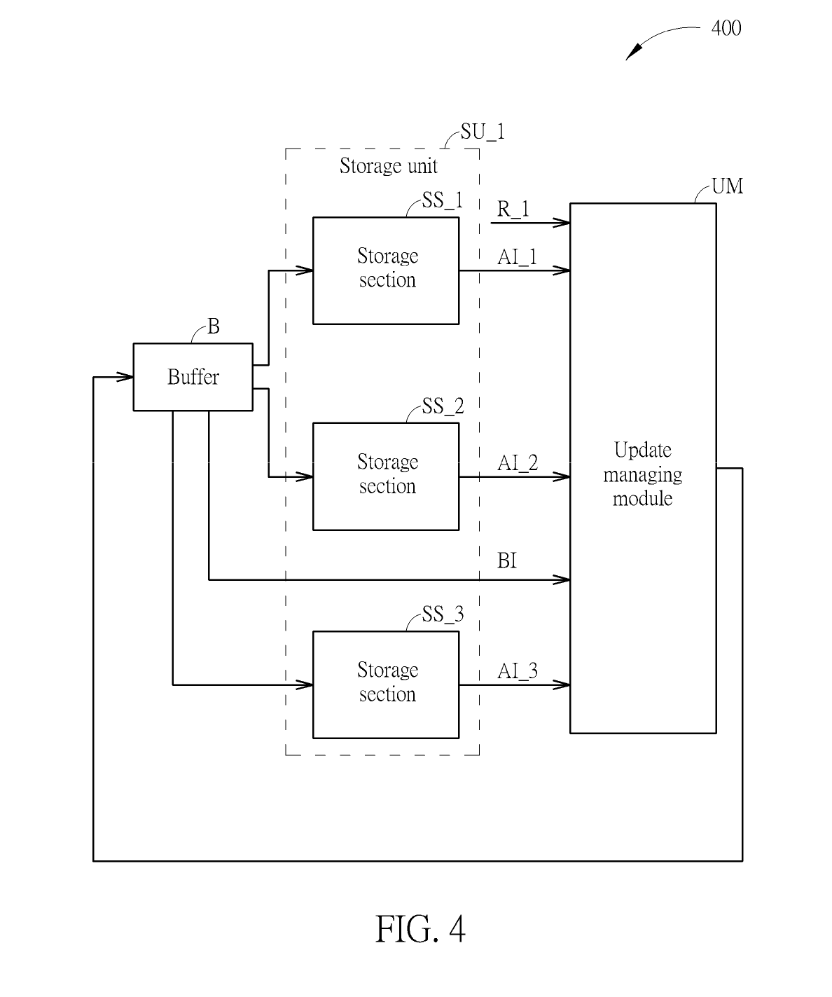

FIG. 4 is a block diagram illustrating a network switch according to another embodiment of the present application. Compared with the embodiment of FIG. 3, the network switch 400 in the embodiment of FIG. 4 comprises more storage sections sharing the same buffer. For more detail, the first storage unit SU_1 in the embodiment of FIG. 4 further comprises a third storage section SS_3. In such embodiment, the buffer B is configured to buffer data to be updated to the first storage section SS_1, the data to be updated to the second storage section SS_2, and the data to be updated to the third storage section SS_3 . The update managing module UM assigns the update address according to the buffer information BI and the first update request R_1.

It will be appreciated that the above-mentioned embodiments can be combined. For example, the embodiment in FIG. 3 can further comprises other two storage sections and other two buffers which apply the structure illustrated in FIG. 2.

In one embodiment, the above-mentioned first data base is a MAC address table, but not limited.

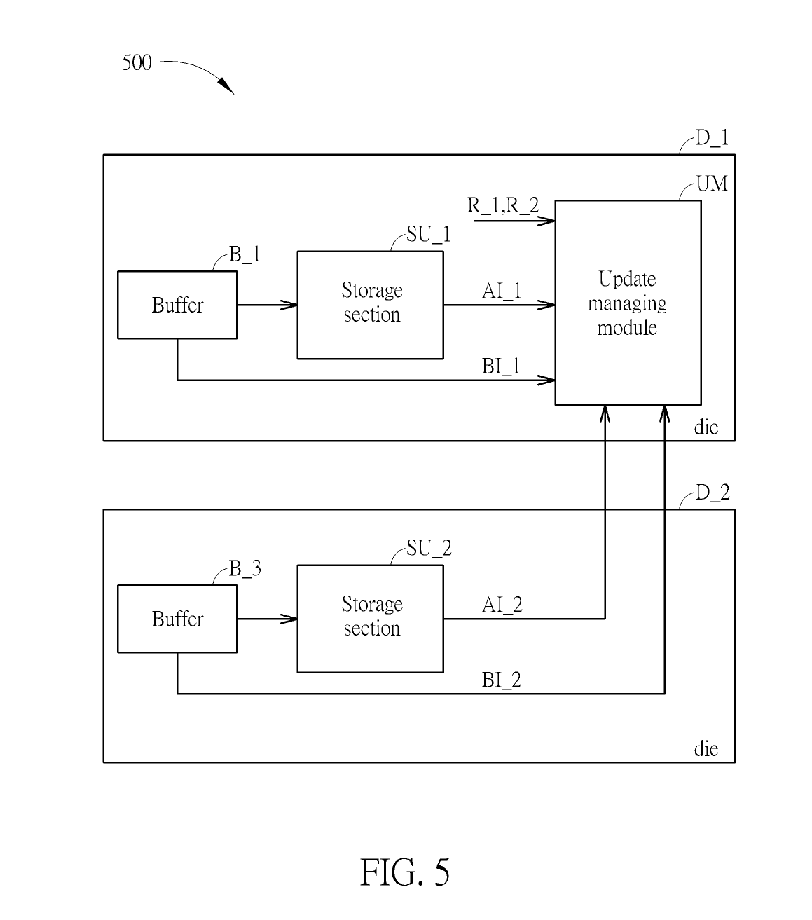

The above-mentioned update managing module UM can be applied to manage devices in different dies. As illustrated in FIG. 5, the network switch 500 comprises a first die D_1 and a second die D_2. The devices illustrated in FIG. 1, that is, the first storage unit SU_1, the first buffer B_1 and the update managing module UM are provided in the first die D_1. Also, the network switch 500 further comprises a second storage unit SU_2 and a third buffer B_3, which are provided in the second die D_2.

In the embodiment of FIG. 5, the third buffer B_3 is configured to buffer data to be updated to the second storage unit SU_2. Also, the update managing module UM assigns the first update address for the first storage unit SU_1 and the second update address for the second storage unit SU_2 according to the first buffer information BI_1 for the first buffer B_1, and the third buffer information BI_3 for the third buffer B_3, the first update request R_1 associated with the first storage unit SU_1, and the second update request R_2 associated with the second storage unit SU_2.

In one embodiment, the first update address and the second update address are assigned to be the same. Also, in one embodiment, the first storage unit SU_1 and the second storage unit SU_2 belong to a single data transmitting path (ex. a pipe line module or a port).

The embodiment illustrated in FIG. 5 can be summarized as: a network switch, comprising: a first die (ex. D_1 in FIG. 5) ; a second die (ex. D_2 in FIG. 5); and an update managing module (EX. UM in FIG. 5), configured to assign an update address for at least one storage unit according to bandwidth information from the first die and the second die.

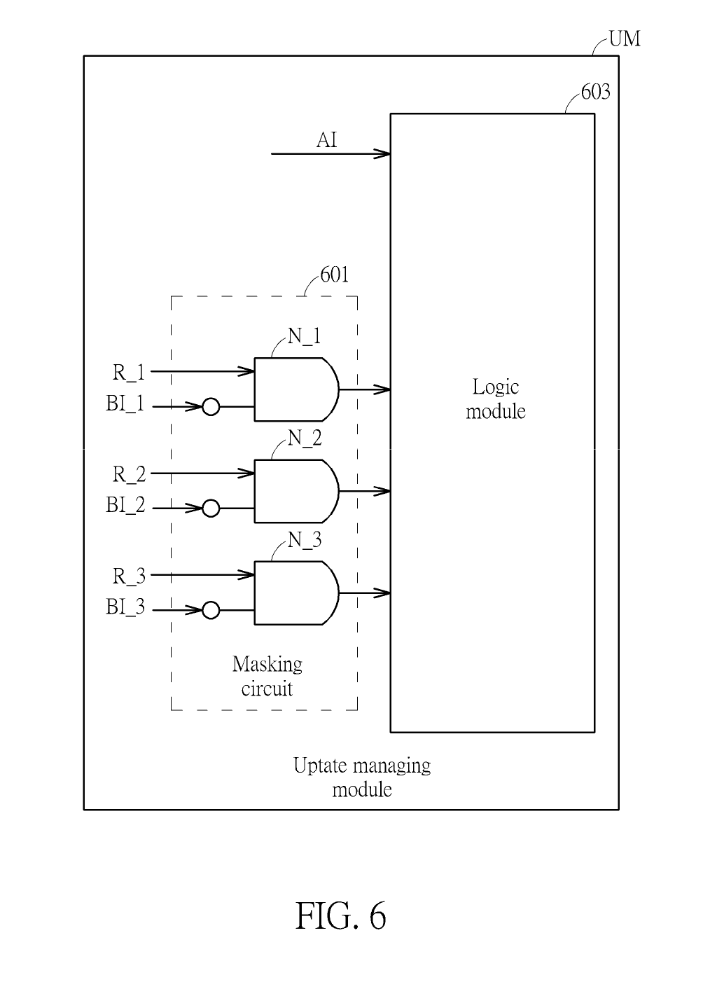

FIG. 6 is a circuit diagram illustrating a detail structure for the update managing module according to one embodiment of the present invention. As illustrated in FIG. 6, the update managing module UM comprises a masking circuit 601 and a logic module 603. The masking circuit 601 comprises a plurality of logic gates N_1, N_2, N_3, which respectively receives different update requests R_1, R_2, R_3 and buffer information BI_1, BI_2, BI_3.

Accordingly, the buffer information BI_1, BI_2, BI_3 can control the masking circuit 601 to change the update requests R_1, R_2, R_3 or not. For example, if the buffer information BI_1, BI_2, BI_3 indicates the paths corresponding to addresses required by the update requests R_1, R_2, R_3 have sufficient bandwidth, the update requests R_1, R_2, R_3 directly received by the update managing module UM and the data to be updated are transmitted to the addresses required by the update requests R_1, R_2, R_3. On the contrary, if the buffer information BI_1, BI_2, BI_3 indicates the paths corresponding to addresses required by the update requests R_1, R_2, R_3 do have sufficient bandwidths, the update requests R_1, R_2, R_3 are changed by the buffer information BI_1, BI_2, BI_3 thus the data to be updated are transmitted to other addresses.

It will be appreciated that the update managing module UM is not limited to the embodiment illustrated in FIG. 6.

According to above-mentioned embodiments, a data base updating method can be acquired, which comprises following steps: buffering data to be updated to a first data base stored in a first storage unit via a first buffer; and assigning a first update address for the first data base according to a first update request and first buffer information for the first buffer. Other detail steps can be acquired according to above-mentioned embodiments, thus are omitted for brevity here.

For a conventional network switch, if the memory does not have enough write bandwidth, the learning process fails and needs to repeat again. If such problem always occurs, the learning rate, which means the efficiency for learning relations between the MAC addresses and the pipe lines, is decreased. Based upon above-mentioned embodiments, the real-time bandwidth information can be acquired such that the update address can be efficiently assigned to avoid the conventional issue. By this way, the learning rate can be increased.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A network switch, comprising:
a first storage unit, configured to store a first data base;
a first buffer, configured to buffer data to be updated; and
an update managing module, configured to assign a first update address of the first storage unit, which is for the data to be updated, according to first buffer information for the first buffer and a first update request.

2. The network switch of claim 1, wherein the update managing module assigns an address requested by the first update request as the first update address if the first buffer information indicates a path to the address requested by the first update request has sufficient bandwidth, and assigns an address different from the address requested by the first update request as the first update address if the first buffer information indicates the path to the address requested by the first update request does not have sufficient bandwidth.

3. The network switch of claim 1, wherein the first storage unit comprises a first storage section and a second storage section, wherein the first buffer is configured to buffer data to be updated to the first storage section, wherein the network switch further comprises a second buffer configured to buffer data to be updated to the second storage section, wherein the update managing module assigns the first update address according to the first buffer information, second buffer information for the second buffer, and the first update request.

4. The network switch of claim 1, wherein the first storage unit comprises a first storage section and a second storage section, wherein the first buffer is configured to buffer data to be updated to the first storage section and the second storage section, wherein the update managing module assigns the first update address according to the first buffer information and the first update request.

5. The network switch of claim 4, wherein the first storage unit further comprises a third storage section, wherein the first buffer is further configured to buffer data to be updated to the third storage section.

6. The network switch of claim 1, further comprising:
a second storage unit, configured to store a second data base;
a third buffer, configured to buffer data to be updated to the second storage unit; and
wherein the update managing module assigns the first update address and a second update address for the second storage unit, according to the first buffer information, third buffer information for the third buffer, the first update request, and a second update request.

7. The network switch of claim 6, comprising:
a first die;
a second die;
wherein the first storage unit and the first buffer are provided in the first die;
wherein the second storage unit and the third buffer are provided in the second die.

8. The network switch of claim 6, wherein the first update address and the second update address are the same.

9. The network switch of claim 1, wherein the first data base is a MAC address table.

10. A network switch, comprising:
a first die;
a second die; and
an update managing module, configured to assign at least one update address for at least one storage unit according to bandwidth information from the first die and the second die.

11. A data base updating method, comprising:
buffering data to be updated via a first buffer; and
assigning a first update address of the first storage unit, which is for the data to be updated, according to a first update request and first buffer information for the first buffer.

12. The data base updating method of claim 11, wherein the step of assigning a first update address comprises:
assigning an address requested by the first update request as the first update address if the first buffer information indicates a path to the address requested by the first update request has sufficient bandwidth; and
assigning an address different from the address requested by the first update request as the first update address if the first buffer information indicates the path to the address requested by the first update request does not have sufficient bandwidth.

13. The data base updating method of claim 11,
wherein the first storage unit comprises a first storage section and a second storage section, wherein the first buffer is configured to buffer data to be updated to the first storage section,
wherein the data base updating method further comprising:
buffering data to be updated to the second storage section via a second buffer; and
assigning the first update address according to the first buffer information, second buffer information for the second buffer, and the first update request.

14. The data base updating method of claim 13, wherein the first storage section and the second storage section belong to a single data transmitting path.

15. The data base updating method of claim 11, wherein the first storage unit comprises a first storage section and a second storage section, wherein the first buffer is configured to buffer data to be updated to the first storage section and the second storage section,
wherein the data base updating method further comprises: assigning the first update address according to the first buffer information and the first update request.

16. The data base updating method of claim 15, wherein the first storage unit further comprises a third storage section, wherein the first buffer is further configured to buffer data to be updated to the third storage section.

17. The data base updating method of claim 11, further comprising:
buffering data to be updated to a second storage unit according via a third buffer;
wherein the data base updating method further comprises:
assigning the first update address and a second update address for the second storage unit, according to the first buffer information, third buffer information for the third buffer, the first update request, and a second update request.

18. The data base updating method of claim 17, comprising:
a first die;
a second die;
wherein the first storage unit and the first buffer are provided in the first die;
wherein the second storage unit and the third buffer are provided in the second die.

19. The data base updating method of claim 18, wherein the first update address and the second update address are the same.

20. The data base updating method of claim 18, wherein the first data base is a MAC address table.
